(19) United States
(12) Patent Application Publication
(10) Pub. No.: US 2019/0238993 A1
(43) Pub. Date: Aug. 1, 2019

(54) SOUND GENERATING DEVICE AND METHOD OF MANUFACTURING SOUND GENERATING DEVICE

(71) Applicant: ALPS ALPINE CO., LTD., Tokyo (JP)

(72) Inventors: Kiyoshi SATO, Niigata (JP); Taishi NUMATA, Niigata (JP); Daigo AOKI, Niigata (JP); Yutaka SATO, Niigata (JP)

(21) Appl. No.: 16/380,041

(22) Filed: Apr. 10, 2019

Related U.S. Application Data
(63) Continuation of application No. PCT/JP2017/033075, filed on Sep. 13, 2017.

(30) Foreign Application Priority Data
Oct. 26, 2016 (JP) 2016-209134

(51) Int. Cl. H04R 11/02; H04R 31/00; H04R 9/02; B23K 26/22

(52) U.S. Cl. CPC H04R 11/02; B23K 26/22; H04R 9/02; H04R 31/00

(57) ABSTRACT

A sound generating device includes an armature having a fixing part facing a first direction and overlapped on an outer surface of a yoke, an extension part extending from the fixing part in a second direction opposite to the first direction, and a movable part bent from the extension part and extending in the first direction, inserted into a coil to oppose a magnet, and connected to an oscillator. The fixing part includes two opposing edge parts that are spot-welded to the outer surface of the yoke at two reference weld areas separated in a perpendicular direction that is perpendicular to the first and second directions. The two opposing edge parts of the fixing part and the outer surface of the yoke are spot-welded at at least one additional weld area at a position separated in the first direction from the reference weld areas.

### CROSS-REFERENCE TO RELATED APPLICATIONS

This application is a continuation application of International Application No. PCT/JP2017/033075 filed on Sep. 13, 2017 and designated the U.S., which is based upon and claims priority to Japanese Patent Application No. 2016-209134, filed on Oct. 26, 2016, the entire contents of which are incorporated herein by reference.

### BACKGROUND OF THE INVENTION

### 1. Field of the Invention

The present invention relates to a sound generating device and a method of manufacturing the sound generating device. More particularly, the present invention relates to a sound generating device having a structure in which a fixed part on a base end of an armature is fixed to an outer surface of a yoke supporting a magnet.

### 2. Description of the Related Art For example, U.S. Pat. No. 6,654,477 proposes a receiver, that is a sound generating device, and a method of manufacturing the receiver.

Prior art described in U.S. Pat. No. 6,654,477 has an armature that is resistance welded to a magnet stack. However, the resistance welding may damage the weld area. In addition, because this type of receiver is quite small, it is very difficult to limit or control the weld area.

Hence, U.S. Pat. No. 6,654,477 proposes laser welding peripheral edges of the armature to the magnet stack at two weld joints. Because the weld joints are limited to the peripheral edges of the armature, heating of the magnet stack is minimized.

In other words, in the receiver and the method of manufacturing the receiver proposed in U.S. Pat. No. 6,654,477, the peripheral edges of the armature are laser welded to the magnet stack, to fix the armature and the magnet stack using minimum heating.

However, the peripheral edges of the armature and the magnet stack of U.S. Pat. No. 6,654,477 are laser welded at two weld joints near end parts closest to a base end of the armature. For this reason, when the armature is driven by a magnetic driving circuit in a direction in which a plate thickness is oriented, a thickness of a magnetic gap between the base end of the armature and a surface of the magnet stack may easily vary. As a result, an impedance of the receiver becomes unstable, a resonance may easily occur in a predetermined frequency region. When generating sound, noise, such as the so-called long sound, may occur.

### SUMMARY OF THE INVENTION

One object of the embodiments of the present invention is to provide a sound generating device and a method of manufacturing the sound generating device, that can minimize weld areas between an armature and a yoke, and stabilize impedance, so that the noise, such as the so-called long sound, can be reduced.

According to one aspect of the embodiments, a sound generating device includes a yoke made of a magnetic material; a magnet supported by the yoke; a coil provided alongside the magnet; an armature; an oscillator; and a case accommodating the yoke, the magnet, the coil, the armature, and the oscillator, wherein the armature includes a fixing part facing a first direction and overlapped on an outer surface of the yoke, an extension part extending from the fixing part in a second direction opposite to the first direction, and a movable part bent from the extension part and extending in the first direction, wherein the movable part is inserted into the coil to oppose the magnet, and is connected to the oscillator, wherein the fixing part includes two opposing edge parts that are spot-welded to the outer surface of the yoke at two reference weld areas that are separated in a perpendicular direction that is perpendicular to the first direction and the second direction, and wherein the two opposing edge parts of the fixing part and the outer surface of the yoke are spot-welded at at least one additional weld area at a position separated in the first direction from the reference weld areas.

Preferably, the two opposing edge parts of the fixing part, formed with the reference weld areas, are welded to the outer surface of the yoke at the additional weld area.

In other words, an even number of additional weld areas may be formed at two or more positions.

Preferably, the two reference weld areas are formed at positions approximately aligned to an end part of the yoke on a side along the second direction.

According to another aspect of the embodiments, a method of manufacturing a sound generating device including a yoke made of a magnetic material, a magnet supported by the yoke, a coil provided alongside the magnet, an armature, an oscillator, and a case accommodating the yoke, the magnet, the coil, the armature, and the oscillator, includes forming on the armature, a fixing part facing a first direction, an extension part extending from the fixing part in a second direction opposite to the first direction, and a movable part bent from the extension part and extending in the first direction; inserting the movable part into the coil to oppose the magnet, and overlapping the fixing part on an outer surface of the yoke; spot-welding two edge parts of the fixing part, located at positions along a perpendicular direction that is perpendicular to the first direction and the second direction, to the outer surface of the yoke; moving the yoke relative to a welding apparatus in the first direction or the second direction, and spot-welding the two edge parts of the fixing part to the outer surface of the yoke, to fix the fixing part to the outer surface of the yoke; and connecting the movable part and the oscillator after fixing the fixing part to the outer surface of the yoke.

Preferably, the method of manufacturing the sound generating device further includes spot-welding the two edge parts of the fixing part to the outer surface of the yoke, to form reference weld areas; and moving the yoke relative to the welding apparatus in the second direction after forming the reference weld areas, and spot-welding the two edge parts of the fixing part to the outer surface of the yoke at positions separated in the first direction from the reference weld areas, to foil the additional weld areas.

The method of manufacturing the sound generating device may further include forming an even number of additional weld areas at two or more positions.

The method of manufacturing the sound generating device may further include emitting laser beams from two laser emitting parts of the welding apparatus, located at opposing positions along the perpendicular direction, toward the two edge parts of the fixing part, wherein the two laser beams travel in oblique irradiating directions such that the two laser beams approach each other toward the armature.

Other objects and further features of the present invention will be apparent from the following detailed description when read in conjunction with the accompanying drawings.

### BRIEF DESCRIPTION OF DRAWINGS

FIG. 1 is a perspective view illustrating an external appearance of a sound generating device in one embodiment of the present invention;

FIG. 2 is a disassembled perspective view illustrating the sound generating device in one embodiment of the present invention;

FIG. 3 is a cross sectional view illustrating the sound generating device cut along a line in FIG. 1;

FIG. 4 is a cross sectional view illustrating the sound generating device illustrated in FIG. 3 in a disassembled state;

FIG. 5 is a plan view illustrating a state in which a diaphragm, a first yoke, and an armature are mounted on a frame of the sound generating device in one embodiment;

FIG. 6 is a cross sectional view illustrating the sound generating device cut along a line VI-VI in FIG. 3;

FIG. 7A and FIG. 7B respectively are a plan view and a side view for explaining weld areas of the sound generating device in a first embodiment of the present invention;

FIG. 8A and 8B respectively are a plan view and a side view for explaining the weld areas of the sound generating device in a second embodiment of the present invention;

FIG. 9A and FIG. 9B respectively are a plan view and a side view for explaining the weld areas of the sound generating device in a third embodiment of the present invention;

FIG. 10A and FIG. 10B respectively are a plan view and a side view for explaining the weld areas of the sound generating device in a comparison example;

FIG. 11 is a cross sectional view illustrating a process in which a welding operation is performed by irradiating a laser beam, from the same direction as FIG. 6;

FIG. 12 is a graph illustrating a relationship between a length of the armature and an amplitude;

FIG. 13A is a graph illustrating sound pressure and impedance properties of the sound generating device in the first embodiment;

FIG. 13B is a graph illustrating an impedance variation rate in the first embodiment;

FIG. 14A is a graph illustrating the sound pressure and the impedance properties of the sound generating device in the third embodiment;

FIG. 14B is a graph illustrating the impedance variation rate in the second embodiment and the third embodiment;

FIG. 15A is a graph illustrating the sound pressure and the impedance properties of the sound generating device in the comparison example;

FIG. 15B is a graph illustrating the impedance variation rate in the comparison example;

FIG. 16 is a graph illustrating a relationship between a number of weld areas and the noise variation rate;

FIG. 17A is a graph illustrating a noise level of the so-called long sound in the first embodiment;

FIG. 17B is a graph illustrating the noise level of the so-called long sound in the third embodiment; and

FIG. 17C is a graph illustrating the noise level of the so-called long sound in the comparison example.

### DESCRIPTION OF THE PREFERRED EMBODIMENTS

### Structure of Sound Generating Device 1

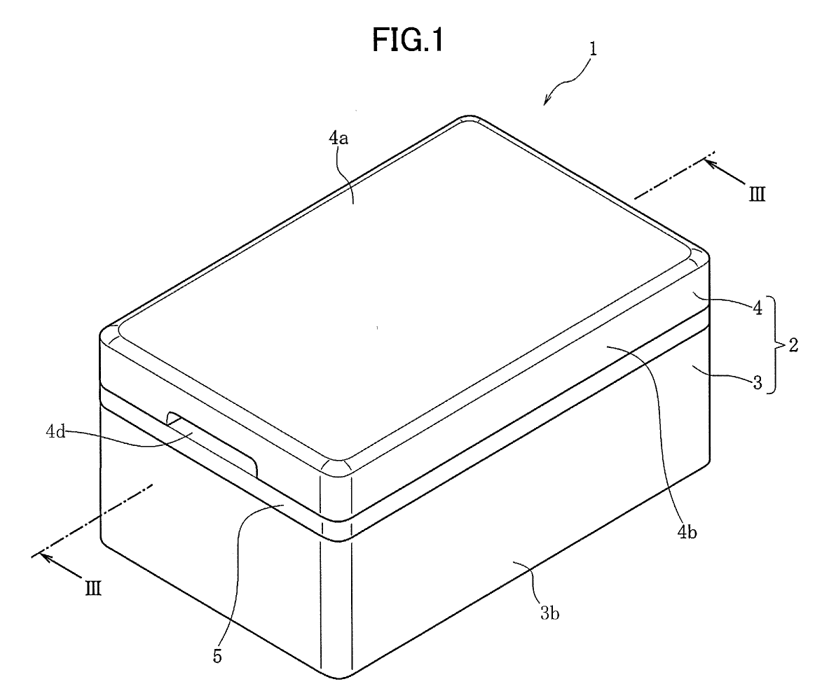

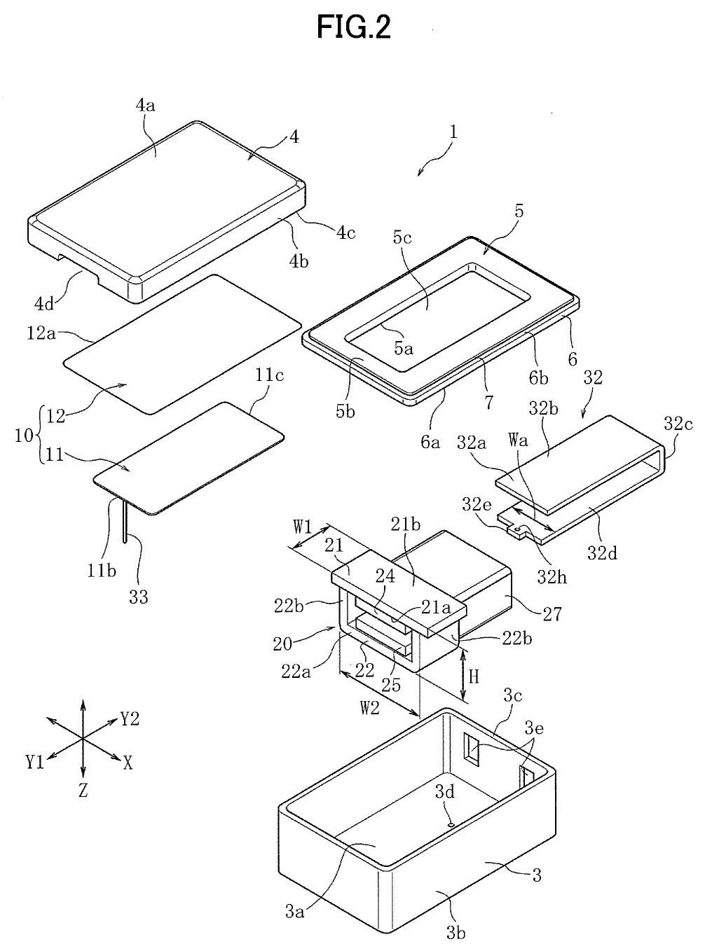

As illustrated in FIG. 1 and FIG. 2, for example, a sound generating device 1 in one embodiment of the present invention includes a case 2. The case 2 is made up of a first case 3, and a second case 4. The first case 3 forms a lower case, and the second case 4 forms an upper case. Both the first case 3 and the second case 4 are formed from a nonmagnetic metal plate or magnetic metal plate by pressing.

As illustrated in FIG. 2, the first case 3 includes a bottom part 3a, a sidewall part 3b surrounding four sides, and an opening end 3c formed at an upper end of the sidewall part 3b. The second case 4 includes a top part 4a, a sidewall part 4b surrounding four sides, and an opening end 4c formed at a lower end of the sidewall part 4b. An internal space of the first case 3 is larger than an internal space of the second case 4, and the second case 4 functions as a lid of the first case 3.

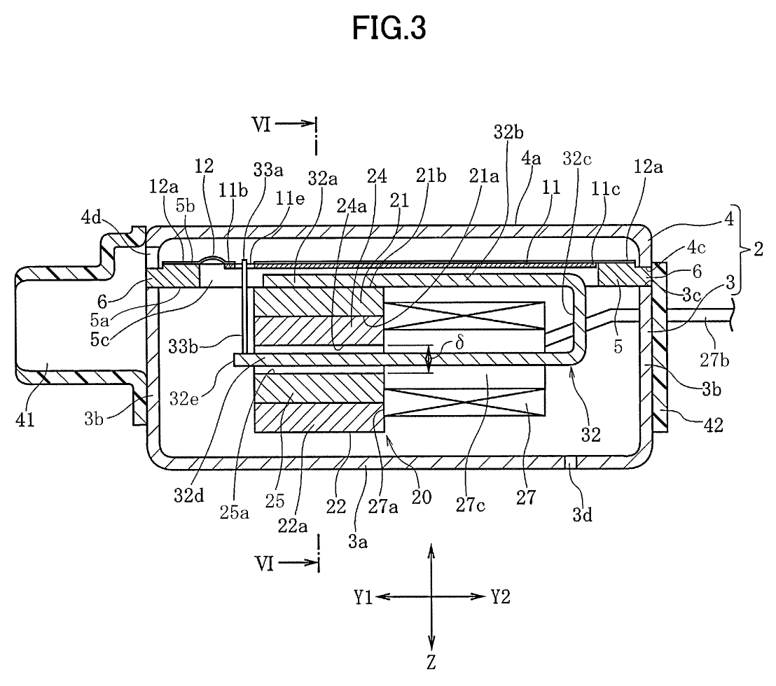

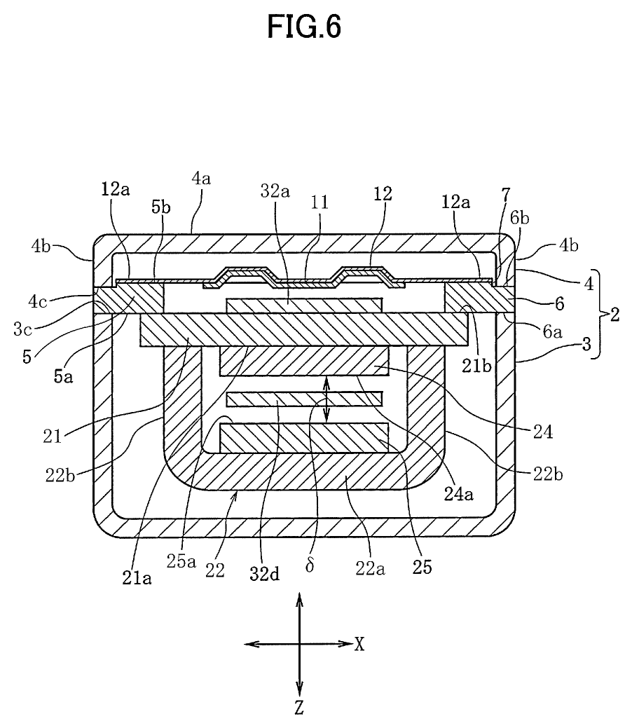

As illustrated in FIG. 3 and FIG. 6, a frame 5 is sandwiched between the open end 3c of the first case 3 and the open end 4c of the second case 4. As illustrated in FIG. 2, the frame 5 is formed by a metal plate made of a nonmagnetic material or a magnetic material, and a has a uniform thickness in a Z-direction. An opening 5c that penetrates the frame 5 from top to bottom, is formed at a central part of the frame 5. The opening 5c has a rectangular shape.

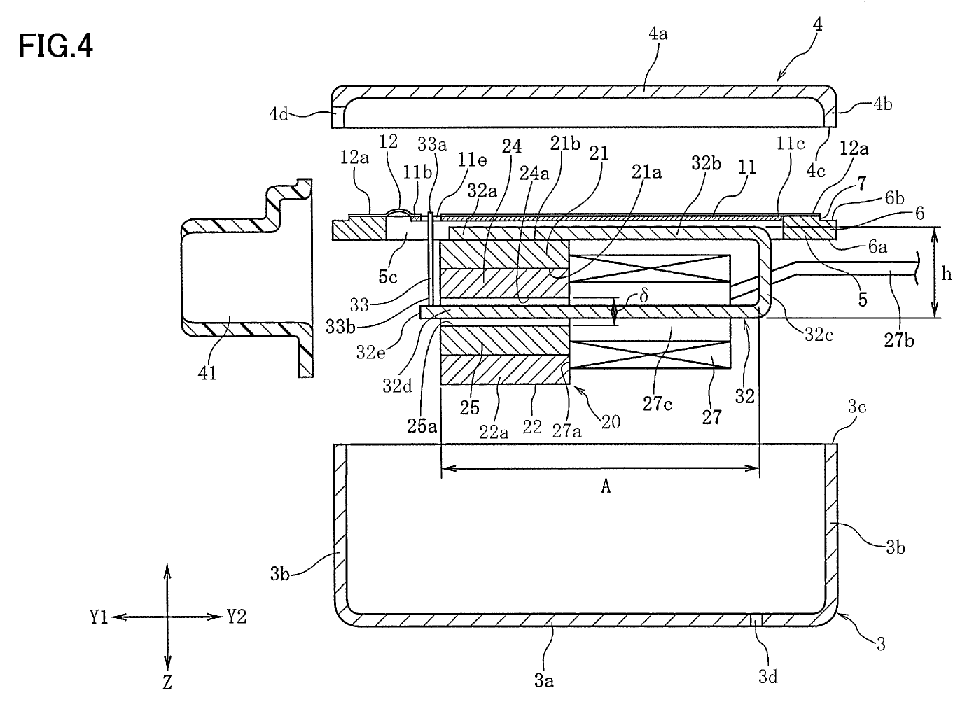

An upper surface of the frame 5, at a peripheral part of the opening 5c in FIG. 2, folios an oscillator mounting surface 5b. The oscillator mounting surface 5b is a frame-shaped plane. A flange part 6, having a thickness smaller than the thickness of the frame 5, is integrally formed around the entire periphery of the oscillator mounting surface 5b. As illustrated in FIG. 3, FIG. 4, and FIG. 6, an upper abutting surface 6b of the flange part 6 faces the same direction as the oscillator mounting surface 5b. A stepped part 7 is famed between the oscillator mounting surface 5b and the upper abutting surface 6b.

The frame 5 is formed from a metal plate having a uniform thickness by pressing. The opening 5c is formed by punching the metal plate. In addition, the flange part 6 is formed by squeezing the peripheral part of the oscillator mounting surface 5b so as to reduce the thickness in the Z-direction. By squeezing the peripheral part of the oscillator mounting surface 5b, it is possible to form the flange part 6 and simultaneously improve rigidity of the frame 5.

A lower surface of the frame 5, at a peripheral part of the opening 5c in FIG. 2, forms a driving mechanism mounting surface 5a. A lower surface of the flange part 6 in FIG. 2 forms a lower abutting surface 6a. The driving mechanism mounting surface 5a and the lower abutting surface 6a lie on the same plane. However, a stepped part may also be provided between the driving mechanism mounting surface 5a and the lower abutting surface 6a.

As illustrated in FIG. 3 and FIG. 4, an oscillator 10 is mounted on the oscillator mounting surface 5b at the upper side of the frame 5. The oscillator 10 is formed by a diaphragm 11 and a diaphragm support sheet 12. The diaphragm 11 is made of a thin metal material such as aluminum, SUS304, or the like. If necessary, ribs may be formed on the diaphragm 11 by pressing, in order to increase the bending strength. Although FIG. 6 illustrates a bulge of the ribs formed on the diaphragm 11, the illustration of the ribs is omitted in FIG. 2 for the sake of convenience. The diaphragm support sheet 12 is formed by a resin sheet (or resin film) made of polyethylene terephthalate (PET), nylon, polyurethane, or the like, for example, and is more easily deformed than the diaphragm 11.

The diaphragm 11 and the diaphragm support sheet 12 have rectangular shapes. An area of the diaphragm 11 is smaller than an opening area of the opening 5c in the frame 5, and an area of the diaphragm support sheet 12 is larger than the area of the diaphragm 11. As illustrated in FIG. 6, the diaphragm 11 is connected and fixed to a lower surface of the diaphragm support sheet 12 using an adhesive agent. An outer peripheral edge part 12a of the diaphragm support sheet 12 projects more toward the periphery than an outer peripheral edge of the diaphragm 11. This outer peripheral edge part 12a is fixed to the oscillator mounting surface 5b, that is the frame-shaped upper surface of the frame 5, using an adhesive agent. A free end 11b of the diaphragm 11 can undergo displacement in the Z-direction and oscillate, using a support end part 11c as the fulcrum, due to deformation and elasticity of the diaphragm support sheet 12. The support end part 11c and the free end 11b of the diaphragm 11 are illustrated in FIG. 2, FIG. 3, and FIG. 4.

As illustrated in FIG. 2, FIG. 3, and FIG. 4, a magnetic field generation unit 20, a coil 27, and an armature 32 are mounted on the frame 5. The magnetic field generation unit 20 includes a first yoke 21 and a second yoke 22. A soft magnetic material forming the first yoke 21 and the second yoke 22 may be a Ni-Fe alloy including a Ni-content that is 17 mass % or greater and 50 mass % or less.

As illustrated in FIG. 2, the second yoke 22 is formed to have a U-shape, and includes a bottom part 22a, and a pair of sidewall parts 22b and 22b that are bent upwardly along both sides of the bottom part 22a. Upper end parts of the sidewall parts 22b and 22b are connected to an inner surface 21a of the first yoke 21 that has a plate shape, and the first yoke 21 and the second yoke 22 are fixed by laser spot welding. When the first yoke 21 and the second yoke 22 are fixed, an inner surface of the bottom part 22a of the second yoke 22 becomes parallel to and opposes the inner surface 21a of the first yoke 21.

As illustrated in FIG. 2 through FIG. 4 and FIG. 6, in the magnetic field generation unit 20, a first magnet 24 is fixed to the inner surface 21a of the first yoke 21, and a second magnet 25 is fixed to the inner surface of the bottom part 22a of the second yoke 22. Each of the first and second magnets 24 and 25 are magnetized (or polarized) so that a magnetized surface 24a of the first magnet 24 and a magnetized surface 25a of the second magnet 25 have mutually opposite polarities. A gap δ is provided in the Z-direction between the magnetized surface 24a of the first magnet 24 and the magnetized surface 25a of the second magnet 25.

As illustrated in FIG. 2 and FIG. 3, a coil 27 is provided at a position alongside the magnetic field generation unit 20. The coil 27 is formed by a coated (or insulated) wire that is wound around a winding axis that extends in a Y-direction. A winding end part 27a of the coil 27 facing in the Y-direction connects to and is fixed to the first yoke 21 and the second yoke 22. A support plate famed by a nonmagnetic material may be fixed to a downwardly facing outer surface of the first yoke 21, and a downwardly facing outer winding part of the coil 27 may be connected to this support plate.

As illustrated in FIG. 2, FIG. 3, and FIG. 4, the sound generating device 1 is provided with the armature 32. The armature 32 is formed by a metal plate having a uniform thickness and made of a magnetic material, such as a Ni—Fe alloy, for example. The armature 32 is formed by pressing that includes cutting and bending the metal plate.

In each of the figures illustrating the Y-direction, a Y1-direction is an example of a first direction, and a Y2-direction is an example of a second direction. A base part on the Y1-side of the armature 32 forms a fixing part 32a that is overlapped on an upwardly facing outer surface 21b of the first yoke 21. An extension part 32b is integrally formed on the fixing part 32a and extends in the Y2-direction from the fixing part 32a. The fixing part 32a and the extension part 32b have the same width along an X-direction. However, the fixing part 32a and the extension part 32b may have mutually different widths along the X-direction. An end part on the Y2-side of the extension part 32b is bent into a U-shape at a bent part 32c, and a movable part 32d that extends in the Y1-direction is formed at a part below the bent part 32c. Each of the fixing part 32a and the extension part 32b is parallel to the movable part 32d. As illustrated in FIG. 2, a tip part 32e on a free end side, that is, the Y1-side of the movable part 32d of the armature 32, has a width along the X-direction that is smaller that a width of the movable part 32d along the X-direction. In addition, a connection hole 32h that is formed in the tip end 32e penetrates the tip part 32e from top to bottom.

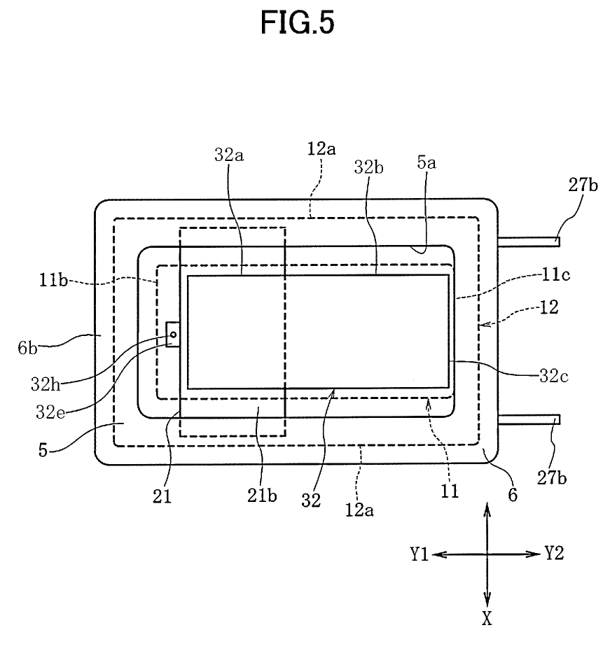

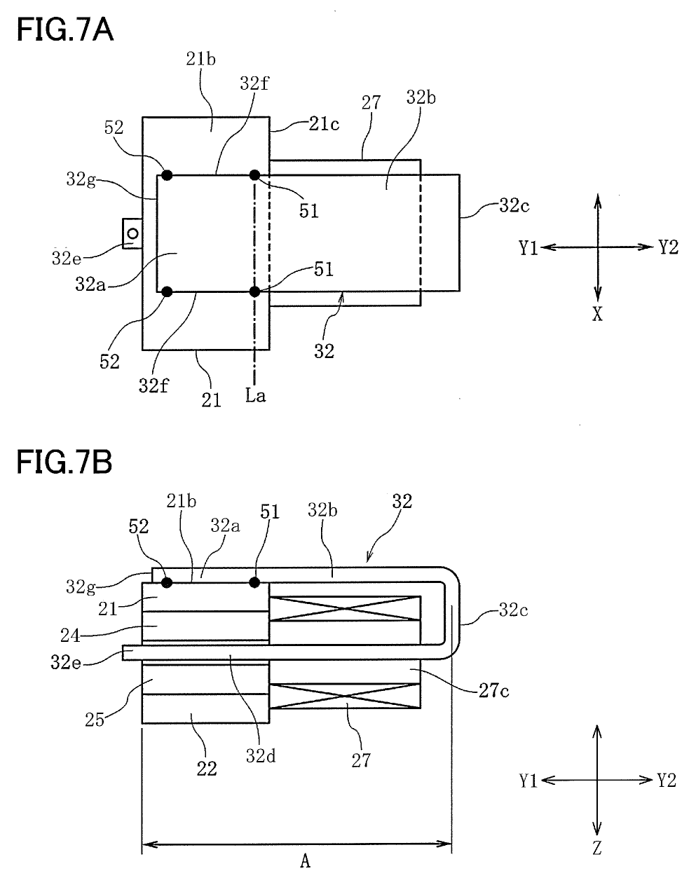

As illustrated in FIG. 3, FIG. 4, and FIG. 5, the fixing part 32a of the armature 32 is fixed to the upwardly facing outer surface 21b of the first yoke 21. As illustrated in FIG. 7A through FIG. 9B, the fixing part 32a and the outer surface 21b are fixed at a plurality of weld areas that are formed by laser spot welding. The movable part 32d of the armature 32 is inserted into a winding space 27c of the coil 27, and is further inserted within the gap δ between the first magnet 24 and the second magnet 25, to oppose each of the first and second magnets 24 and 25. The tip part 32e of the armature 32 extends out more on the Y1-side than the first and second magnets 24 and 25.

As illustrated in FIG. 3 and FIG. 4, the upwardly facing outer surface 21b of the first yoke 21 is connected and fixed to the driving mechanism mounting surface 5a that is formed by the lower surface of the frame 5. As illustrated in FIG. 5 and FIG. 6, the first yoke 21 is arranged to traverse the opening 5a of the frame 5 along the X-direction. Both end parts of the first yoke 21 along the X-direction are connected to the driving mechanism mounting surface 5a of the frame 5, and the first yoke 21 and the frame 5 are fixed by laser spot welding. By fixing the first yoke 21 and the frame 5, the magnetic field generation unit 20 is fixed with reference to the driving mechanism mounting surface 5a of the frame 5.

As illustrated in FIG. 5, a combined area of the fixing part 32a and the extension part 32b of the armature 32 is smaller than the opening area of the opening 5c in the frame 5. Accordingly, when the outer surface 21b of the first yoke 21 is fixed to the driving mechanism mounting surface 5a that is formed by the lower surface of the frame 5, the fixing part 32a of the armature 32 that is fixed to the outer surface 21b and the extension part 32b of the armature 32 enter inside the opening 5c in the frame 5, as illustrated in FIG. 6. A thickness of each of the fixing part 32a and the extension part 32b along the Z-direction is smaller than the thickness of the frame 5 along the Z-direction. In addition, a gap is provided in the Z-direction between the diaphragm 11 that is positioned within the opening 5c, and the fixing part 32a and the extension part 32b of the armature 32, so that the diaphragm 11 can oscillate in the Z-direction.

As illustrated in FIG. 4, the free end 11b of the diaphragm 11, and the tip part 32e on the Y1-side of the movable part 32d of the armature 32, are connected via a transmission body 33. The transmission body 33 is a needle-shaped member formed by a metal or a synthetic resin. The transmission body 33 may be a pin member made of SUS202, for example. An upper end 33a of the transmission body 33 is inserted into a mounting hole lie that is formed in the diaphragm 11, and the diaphragm 11 and the transmission body 33 are fixed by an adhesive agent or by soldering. A lower end 33b of the transmission body 33 is inserted into the connection hole 32h that is formed in the tip part 32e of the movable part 32d, and the transmission body 33 and the tip part 32e are fixed by laser spot welding, or by an adhesive agent, or by soldering. The transmission body 33 traverses inside the opening 5c in the frame 5 from top to bottom of the frame 5, and a part of the transmission body 33 is positioned inside the opening 5c.

As illustrated in FIG. 3 and FIG. 6, the flange part 6 that is integrally formed around the periphery of the frame 5 is fixed in a state sandwiched between the opening end 3c of the first case 3 and the opening end 4c of the second case 4. The opening end 3c of the first case 3 is brought into contact with the lower abutting surface 6a that is formed by the lower surface of the flange part 6, and the opening end 4c of the second case 4 is brought into contact with the upper abutting surface 6b that is formed by the upper surface of the flange part 6. The first case 3 and the second case 4 are fixed to the flange part 6 by laser spot welding or resin encapsulation, to complete the sound generating device 1 illustrated in FIG. 1.

The flange part 6 is integrally formed around the entire periphery of the frame 5, and the stepped part 7 is formed between the oscillator mounting surface 5b and the upper abutting surface 6b that is formed by the upper surface of the flange part 6. For this reason, a connecting part between the upper abutting surface 6b and the opening end 4c of the second case 4, and the oscillator mounting surface 5b, become discontinuous via the stepped part 7. The provision of the stepped part 7 prevents the adhesive agent that adheres the outer peripheral edge part 12a of the diaphragm support sheet 12 from adhering to the connecting part between the upper abutting surface 6b and the opening end 4c of the second case 4.

When the first case 3 and the second case 4 are fixed with the frame 5 interposed therebetween, the space inside the case 2 is partitioned into upper and lower spaces by the diaphragm 11 and the oscillator support sheet 12. The upper space above the diaphragm 11 and the oscillator support sheet 12, inside the second case 4, forms an example of a sound-generating space. The sound-generating space communicates to an external space via a sound-generating opening 4d that is formed in the sidewall part 4b of the second case 4.

As illustrated in FIG. 3, a sound-generating nozzle 41, that communicates to the sound-generating opening 4d, is fixed to an outer side of the case 2. As illustrated in FIG. 2 and FIG. 3, an intake and exhaust opening 3d is formed in the bottom part of the first case 3, and an internal space below the diaphragm 11 and the oscillator support sheet 12, inside the first case 3, communicates to the outside air via the intake and exhaust opening 3d. As illustrated in FIG. 2, a pair of wiring holes 3e are formed in the sidewall part 3b of the first case 3. As illustrated in FIG. 3, a pair of terminal parts 27b of the wire forming the coil 27 are drawn outside via the pair of wiring holes 3e in the sidewall part 3b of the first case 3. A substrate 42 is fixed to an outer part of the sidewall part 3b of the first case 3, and the terminal parts 27b penetrate small holes foiled in the substrate 42. The pair of wiring holes 3e is closed from the outside by covering and closing the small holes in the substrate 42.

### Operation of Sound Generating Device 1

Next, an operation of the sound generating device 1 will be described.

When a voice current is applied to the coil 27, an oscillation force acts on the movable part 32d of the armature 32 in the Z-direction, due to a magnetic field induced at the coil 27 and a magnetic field generated between the magnetized surface 24a of the first magnet 24 and the magnetized surface 25a of the second magnet 25. The oscillation is transmitted to the diaphragm 11 via the transmission body 33. In the diaphragm 11 that is supported by the oscillator support sheet 12, the free end 11b undergoes displacement in the Z-direction and oscillates, using the support end part 11c as the fulcrum. Hence, due to the oscillation transmitted to the diaphragm 11, sound pressure is generated in the sound-generating space inside the second case 4, and the sound pressure is released to the outside via the sound-generating opening 4d.

### Fixing First Yoke 21 and Armature 32

FIG. 7A and FIG. 7B illustrate a first embodiment.

In the armature 32, the Y1-direction is the first direction, and the Y2-direction is the second direction. The X-direction, that is perpendicular to the first direction and the second direction, is an example of a perpendicular direction. As illustrated in FIG. 7A, the fixing part 32a of the armature 32 in this embodiment includes edge parts 32f and 32f that oppose each other in the perpendicular direction (or X-direction). Reference weld areas 51 and 51, and additional weld areas 52 and 52, are formed between the edge parts 32f and 32f and the outer surface 21b of the first yoke 21.

The reference weld areas 51 and 51 are spaced apart along the X-direction on a reference line La that extends in the X-direction. The reference line La is preferably aligned to or is extremely close to an end side 21c of the first yoke 21 facing the Y2-direction. When the reference weld areas 51 and 51 are provided on the reference line La, it becomes possible to prescribe a projecting length of the armature 32 in the Y2-direction from the position of the reference line La. By prescribing the projecting length of the armature 32 from the reference line La to the bent part 32c, it becomes possible to set an amplitude and a natural frequency of the armature 32.

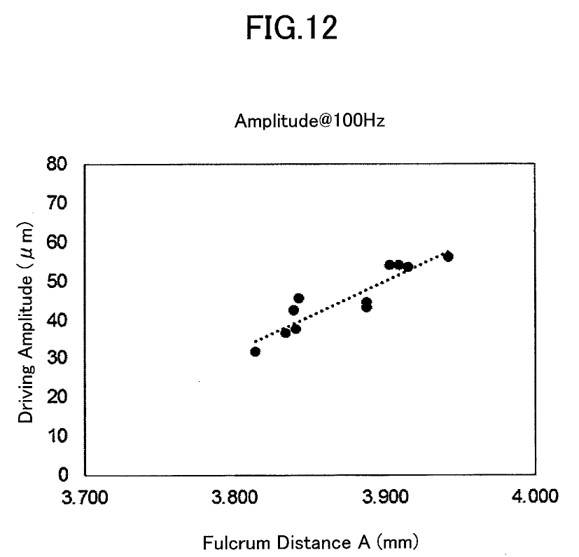

FIG. 12 illustrates a change in a maximum amplitude of the movable part 32d when a free length of the armature 32 from the reference line La to the bent part 32c is varied in the sound generating device 1 in which the reference line La on which the reference weld areas 51 and 51 are formed is positioned extremely close to the end side 21c of the a/mature 32 facing the Y2-direction. Because the sound generating device 1 has a small size, the projecting length of the armature 32 from the reference line La where the reference weld areas 51 and 51 are formed to the bent part 32c were varied, by varying a length A in the Y-direction from the end part on the Y1-side of the first yoke 21 to the bent part 32c of the armature 32, as illustrated in FIG. 4 and FIG. 7B.

Models of the sound generating device 1, in which the length A is varied from 3.814 mm to 3.943 mm, were made. FIG. 12 illustrates the maximum value of the amplitude in the Z-direction of the movable part 32d of the armature 32 when a driving current of 100 Hz is applied to the coil 27. The maximum amplitude when the length A is 3.814 mm was 31.5 μm, and the maximum amplitude when the length A is 3.943 mm was 56 μm. Hence, the amplitude of the movable part 32d varies by 1.78 times by simply varying the distance (length A) from the reference line La to the bent part 32c by 0.129 mm. Accordingly, inconsistencies in the length of the armature 32 projecting in the Y2-direction from the reference line La, that is, the length of the part oscillating in the Z-direction, can be reduced by managing the length A and also forming the reference weld areas 51 and 51 that are spaced apart along the X-direction on the reference line La. As a result, it is possible to obtain a uniform amplitude by matching the maximum amplitude of the movable part 32d to an optimum value.

Next, in the sound generating device 1, the additional weld areas 52 and 52 are formed between the edge parts 32f and 32f of the fixing part 32a of the armature 32, and the outer surface 21b of the first yoke 21, at positions separated more in the first direction (or Y1-direction) than the reference weld parts 51 and 51, as illustrated in FIG. 7A and FIG. 7B. By forming the additional weld areas 52 and 52 in addition to the reference weld areas 51 and 51, it becomes possible to positively fix the fixing part 32a of the armature 32 with respect to the outer surface 21b of the first yoke 21, and stably foist a magnetic gap between the lower surface of the fixing part 32a and the outer surface 21b of the first yoke 21. As a result, it is possible to reduce variation in an impedance of a magnetic driving circuit that is formed by the first and second yokes 21 and 22, the first and second magnets 24 and 25, the coil 27, and the armature 32, and reduce noise, such as the so-called long sound.

In order to stably fix the entire fixing part 32a of the armature 32 to the outer surface 21b of the first yoke 21, the reference line La on which the reference weld areas 51 and 51 are formed is preferably set to a position close to the end side 21c of the first yoke 21 facing the Y2-direction, and the additional weld areas 52 and 52 are preferably formed at positions close to an edge part 32g of the fixing part 32a facing the Y1-direction.

Only single additional weld area 52 may be formed only at a center part along the X-direction of the edge part 32g of the fixing part 32 facing the Y1-direction. Even in this case, the reference weld areas 51 and 51 and the single additional weld area 52 can provide the effect of stably fixing the fixing part 32a to the outer surface 21b of the first yoke 21. However, as illustrated in FIG. 7A, it is possible to more stably fix the fixing part 32a to the outer surface of the 21b of the first yoke 21, by arranging an even number of additional weld areas 52 along the X-direction, and setting a centerline of the even number of additional weld areas 52 to become parallel to the reference line La.

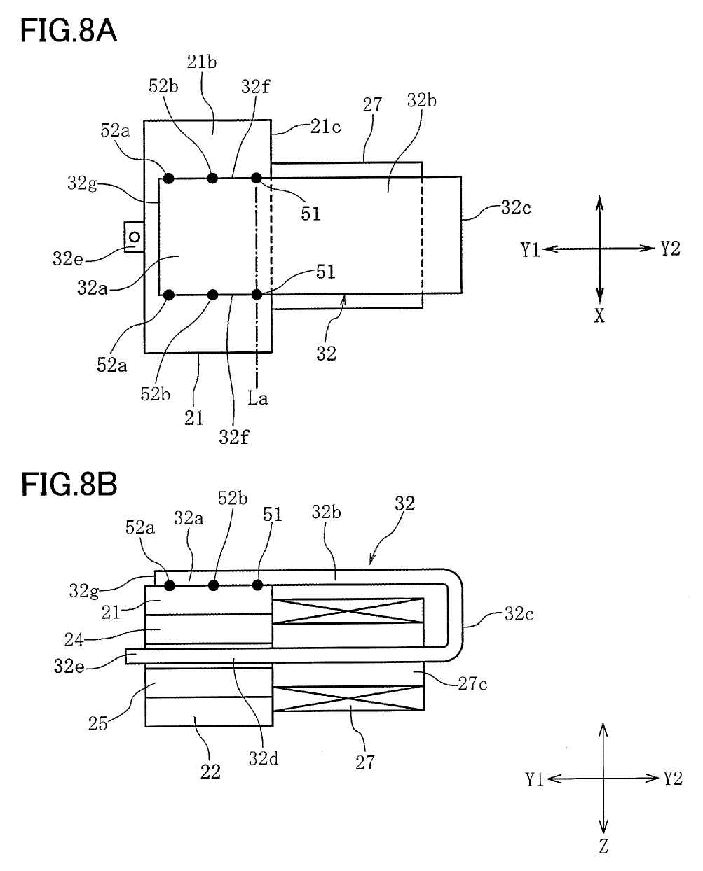

FIG. 8A and FIG. 8B illustrate a second embodiment.

The sound generating device 1 in this embodiment, the reference line La is aligned to or is extremely close to the end side 21c of the first yoke 21 facing the Y2-direction. The reference weld areas 51 and 51 are formed on the reference line La, and the two edge parts 32f and 32f of the fixing part 32a and the outer surface 21b of the first yoke 21 are welded on the reference line La. In addition, two additional weld areas 52a and 52a are formed on the Y1-side of the reference line La, at positions close to the edge part 32g of the fixing part 32a facing the Y1-direction. Further, two additional weld areas 52b and 52b are formed between the reference weld areas 51 and 51 and the additional weld areas 52a and 52a.

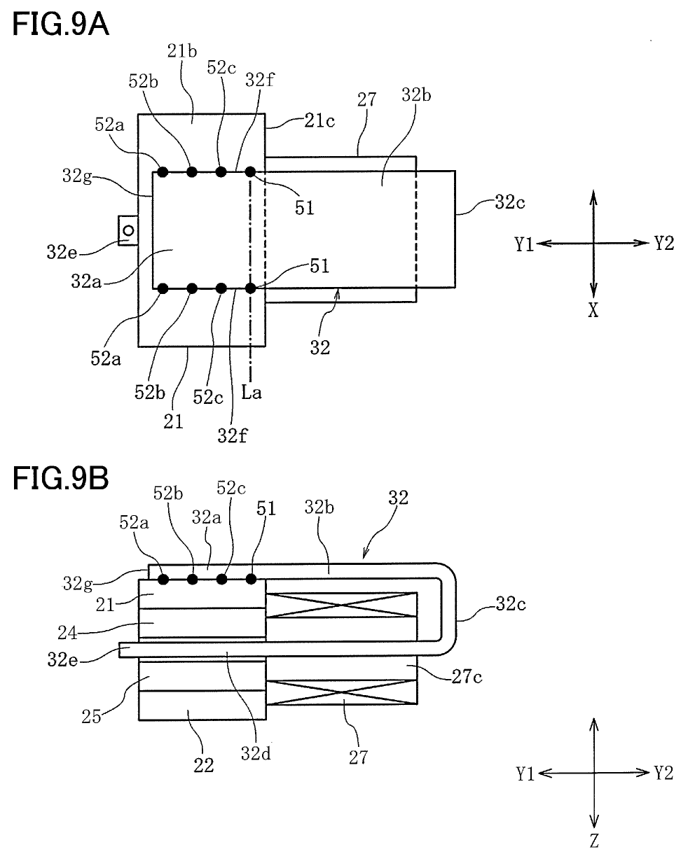

FIG. 9A and FIG. 9B illustrate a third embodiment.

The sound generating device 1 in this embodiment, the reference line La is aligned to or is extremely close to the end side 21c of the first yoke 21 facing the Y2-direction. The reference weld areas 51 and 51 are formed on the reference line La, and the two edge parts 32f and 32f of the fixing part 32a and the outer surface 21b of the first yoke 21 are welded on the reference line La. In addition, two additional weld areas 52a and 52a are formed on the Y1-side of the reference line La, at positions close to the edge part 32g of the fixing part 32a facing the Y1-direction. Further, two additional weld areas 52b and 52b and two additional weld areas 52c and 52c are formed between the reference weld areas 51 and 51 and the additional weld areas 52a and 52a. In other words, the second embodiment illustrated in FIGS. 8A and 8B has the additional weld areas formed at four locations, but the third embodiment illustrated in FIGS. 9A and 9B has the additional weld areas formed at six locations.

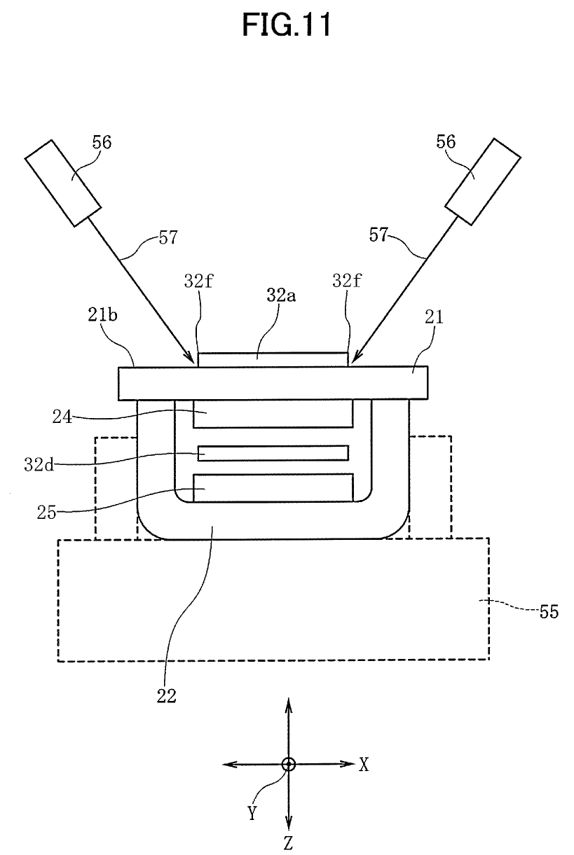

FIG. 11 illustrates a process in which the fixing part 32a of the armature 32 is fixed to the outer surface 21b of the first yoke 21 in the method of manufacturing the sound generating device 1.

A magnetic driving part, integrally having the coil 27 and the magnetic field generation unit 20 that is formed by the first and second yokes 21 and 22 and the first and second magnets 24 and 25, is set on a stage 55 that moves in the Y-direction and is fixed to the stage 55 using a jig. The movable part 32d of the armature 32 is inserted into the winding space 27c of the coil 27, to oppose the first and second magnets 24 and 25. In addition, the fixing part 32a is positioned on the outer surface 21b of the first yoke 21, and is provisionally fixed thereon.

Two laser emitting parts 56 and 56 of a welding apparatus emit laser beams 57 and 57, respectively. The two laser beams 57 and 57 travel in oblique irradiating directions such that the two laser beams 57 and 57 approach each other toward the armature 32, and irradiate both the two edge parts 32f and 32f of the fixing part 32a, and the outer surface 21b of the first yoke 21, to form the reference weld areas 51 and 51. By first forming the reference weld areas 51 and 51, it becomes possible to determine the length length A in the Y-direction from the end part on the Y1-side of the first yoke 21 to the bent part 32c of the armature 32, as illustrated in FIG. 4.

After forming the reference weld areas 51 and 51, the stage 55 is moved in the Y2-direction, and the two laser beams 57 and 57 are emitted from the same two laser emitting parts 56 and 56, toward both the two edge parts 32f and 32f of the fixing part 32a, and the outer surface 21b of the first yoke 21, to form the additional weld areas 52 and 52 illustrated in FIG. 7A and FIG. 7B. Alternatively, the additional weld areas 52a and 52a, and the additional weld areas 52b and 52b may be formed, as illustrated in FIG. 8A and FIG. 8B. Of course, the additional weld areas 52a and 52a, the additional weld areas 52b and 52b, and the additional weld areas 52c and 52c may be formed instead, as illustrated in FIG. 9A and FIG. 9B.

In the method of manufacturing the sound generating device 1, after fixing the armature 32 to the first yoke 21, the first yoke 1 is further fixed to the frame 5 having the diaphragm 11, as illustrated in FIG. 4. Thereafter, the sound generating device 1 is assembled by sandwiching the frame 5 between the first case 3 and the second case 4.

According to the welding method illustrated in FIG. 11, the welding apparatus requires only two laser emitting parts 56 and 56, and the number of laser emitting parts 56 that are required can be reduced to a minimum. In addition, by moving the stage 55 in the Y2-direction, the reference weld areas 51 and the additional weld areas 52 (52a, 52b, and 52c) can be formed with the same bonding strength using the same laser energy. Further, by obliquely irradiating the laser beams 57 and 57 onto connecting parts of the two edge parts 32f and 32f of the fixing part 32a, and the outer surface 21b of the first yoke 21, it becomes possible to accurately and rigidly weld edge surfaces of the edge parts 32f and 32f to the outer surface 21b.

Moreover, by first forming the reference weld areas 51 and 51 to determine the projecting length of the armature 32 in the Y2-direction from the reference line La, and thereafter forming the additional weld areas 52 (52a, 52b, and 52c), it becomes possible to accurately determine the projecting length, and also stabilize the magnetic gap between the fixing part 32a and the outer surface 21b of the first yoke 21. However, a modification of one embodiment may first form the additional weld areas 52 (52a, 52b, and 52c) and thereafter form the reference weld areas 51.

### (1) FIRST EMBODIMENT

The sound generating device 1 in the first embodiment has the fixing part 32a of the armature 32 and the outer surface 21b of the first yoke 21 fixed at the two reference weld areas 51 and 51 and the two additional weld areas 52 and 52, as illustrated in FIG. 7A and FIG. 7B. In other words, there are four weld areas in total.

A plate thickness of the first yoke 21 and the second yoke 22 is 0.35 mm, a length W1 in the Y-direction of the first yoke 21 and the second yoke 22 in FIG. 2 is 1.6 mm, and a width W2 in the X-direction of the second yoke 22 in FIG. 2 is 2.7 mm. A height H in the Z-direction of the magnetic field generation unit 20 in FIG. 2 is 1.8 mm. AlNiCo magnets are used for the first magnet 24 and the second magnet 25. The number of turns of the coil 27 is 200 turns.

The armature 32 is made of a PB permalloy, that is, an Fe—Ni alloy including 45 mass % of Ni. A plate thickness of the armature 32 is 0.15 mm, a width Wa in the X-direction illustrated in FIG. 2 is 1.8 mm, the length A in the Y-direction illustrated in FIG. 4 is 3.94 mm, a height h in the Z-direction illustrated in FIG. 4 is 1.125 mm.

The diaphragm 11 is made of an aluminum plate having a plate thickness of 0.05 mm.

### (2) SECOND EMBODIMENT

The sound generating device 1 in the second embodiment has the fixing part 32a of the armature 32 and the outer surface 21b of the first yoke 21 fixed at the two reference weld areas 51 and 51 and a total of four additional weld areas 52a, 52a, 52b, and 52b, as illustrated in FIG. 8A and FIG. 8B. In other words, there are six weld areas in total.

Otherwise, the dimensions or the like of the second embodiment are the same as those of the first embodiment.

### (3) THIRD EMBODIMENT

The sound generating device 1 in the third embodiment has the fixing part 32a of the armature 32 and the outer surface 21b of the first yoke 21 fixed at the two reference weld areas 51 and 51 and a total of six additional weld areas 52a, 52a, 52b, 52b, 52c, and 52c, as illustrated in FIG. 9A and FIG. 9B. In other words, there are eight weld areas in total.

Otherwise, the dimensions or the like of the third embodiment are the same as those of the first embodiment.

### (4) Comparison Example

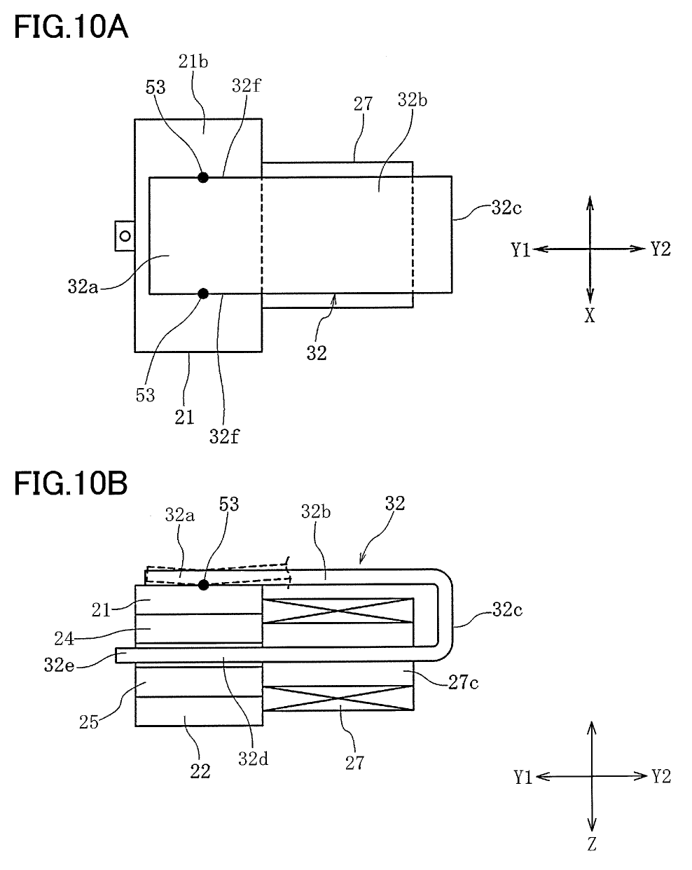

A sound generating device in a comparison example has the fixing part 32a of the armature 32 and the outer surface 21b of the first yoke 21 fixed at only two weld areas 53 and 53, as illustrated in FIG. 10A and FIG. 10B. The weld areas 53 and 53 are formed at a center position of the first yoke 21 along the Y-direction.

Otherwise, the dimensions or the like of the comparison example are the same as those of the first embodiment.

### (5) Impedance and Noise Variation

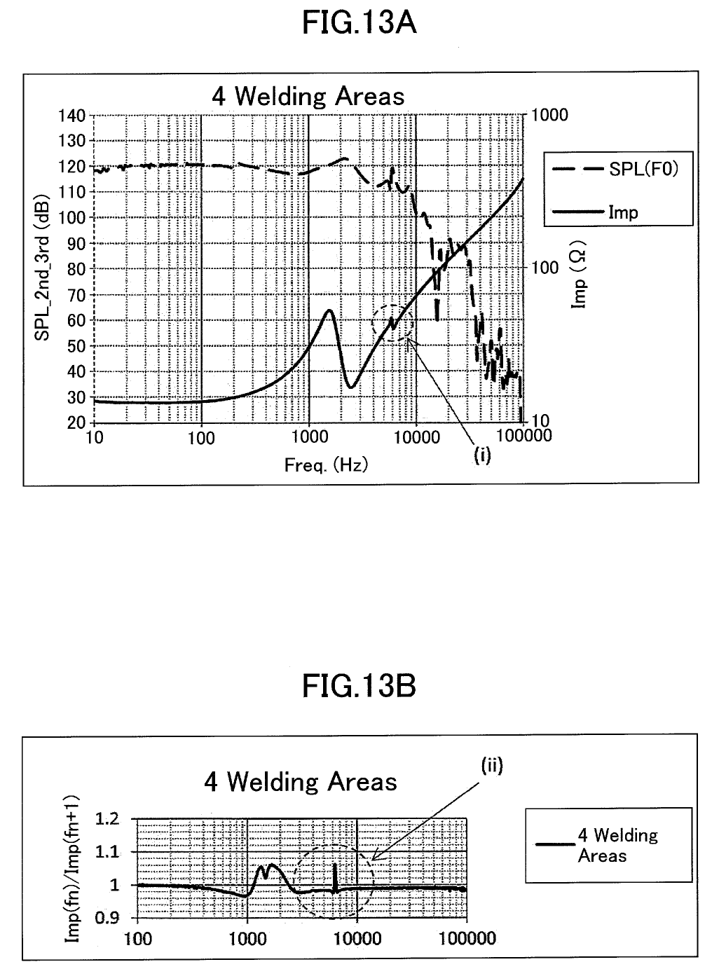

FIG. 13A and FIG. 13B illustrate properties of the sound generating device 1 in the first embodiment. A graph indicated by a dotted line in FIG. 13A illustrates the sound pressure level (SPL, left ordinate in dB) with respect to the frequency (abscissa in Hz) when the sound generating device 1 is driven at 1 mW. A graph indicated by a solid line in FIG. 13A illustrates the impedance (Imp, right ordinate in Ω) with respect to the frequency (abscissa in Hz) when the sound generating device 1 is driven at 1 mW. FIG. 13B illustrates the impedance variation rate of the sound generating device 1, where the abscissa indicates the frequency (Hz), and the ordinate indicates the impedance variation rate (Imp(fn)/Imp(fn+1)) when no variation is regarded as “1”.

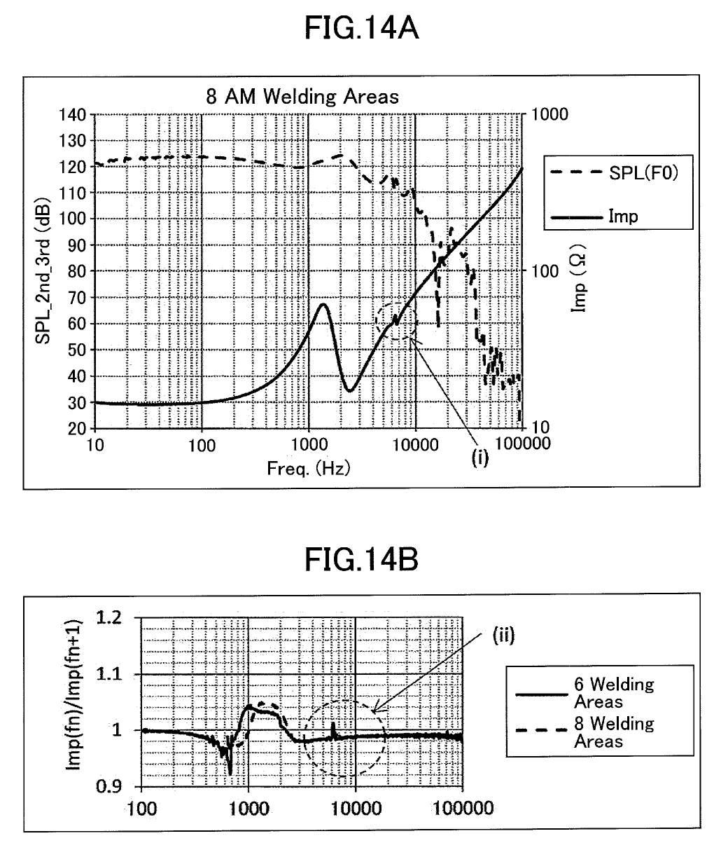

FIG. 14A and FIG. 14B illustrate properties of the sound generating device 1 in the second embodiment and the third embodiment. A graph indicated by a dotted line in FIG. 14A illustrates the SPL (left ordinate in dB) with respect to the frequency (abscissa in Hz) when the sound generating device 1 in the third embodiment is driven at 1 mW. A graph indicated by a solid line in FIG. 14A illustrates the Imp (right ordinate in Ω) with respect to the frequency (abscissa in Hz) when the sound generating device 1 in the third embodiment is driven at 1 mW. FIG. 14B illustrates the impedance variation rate of the sound generating device 1 in the second embodiment by a solid line, and the impedance variation rate of the sound generating device 1 in the third embodiment by a dotted line, where the abscissa indicates the frequency (Hz), and the ordinate indicates the impedance variation rate when no variation is regarded as “1”.

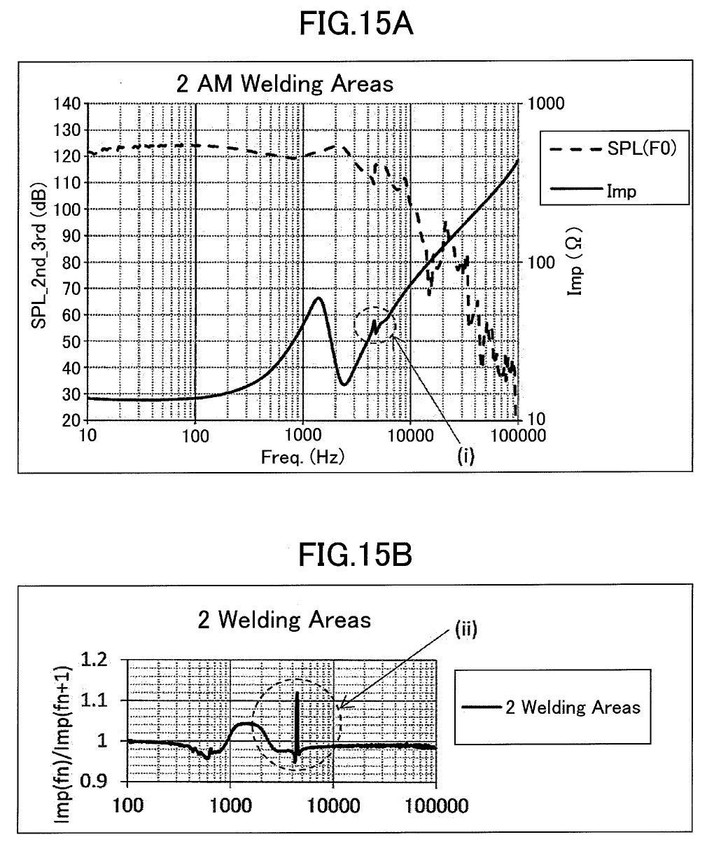

FIG. 15A and FIG. 15B illustrate properties of the sound generating device in the comparison example. A graph indicated by a dotted line in FIG. 15A illustrates the SPL (left ordinate in dB) with respect to the frequency (abscissa in Hz) when the sound generating device is driven at 1 mW. A graph indicated by a solid line in FIG. 15A illustrates the Imp (right ordinate in Ω) with respect to the frequency (abscissa in Hz) when the sound generating device is driven at 1 mW. FIG. 15B illustrates the impedance variation rate of the sound generating device, where the abscissa indicates the frequency (Hz), and the ordinate indicates the impedance variation rate when no variation is regarded as “1”.

According to the impedance variations of the graphs indicated by the solid line in FIG. 13A, FIG. 14A, and FIG. 15A, resonance occurs near a frequency of 4.5 kHz, as indicated by (i). In addition, in FIG. 13B, FIG. 14B, and FIG. 15B, the impedance variation rate becomes large in a frequency band near the same frequency of 4.5 kHz, as indicated by (ii).

It may be predicted that the resonance of the impedance is caused by a change in the magnetic gap between the fixing part 32a and the outer surface 21a of the first yoke 21 when the armature 32 is driven to oscillate in the X-direction.

In the comparison example illustrated in FIG. 15A and FIG. 15B, a large resonance of the impedance appears as indicated by (i), and the impedance variation becomes large as indicated by (ii). This is because the fixing part 32a that is welded only at the two weld areas 53 and 53 easily undergoes an unstable movement as indicated by a dotted line in FIG. 10B when the armature 32 oscillates, and the magnetic gap between the fixing part 32a and the outer surface 21b of the first yoke 21 easily changes as a consequence. On the other hand, as illustrated in FIG. 13A and FIG. 13B, the resonance of the impedance and the impedance variation rate are reduced in the first embodiment. In addition, as illustrated in FIG. 14A and FIG. 14B, the resonance of the impedance and the impedance variation rate are further reduced in the second embodiment and the third embodiment.

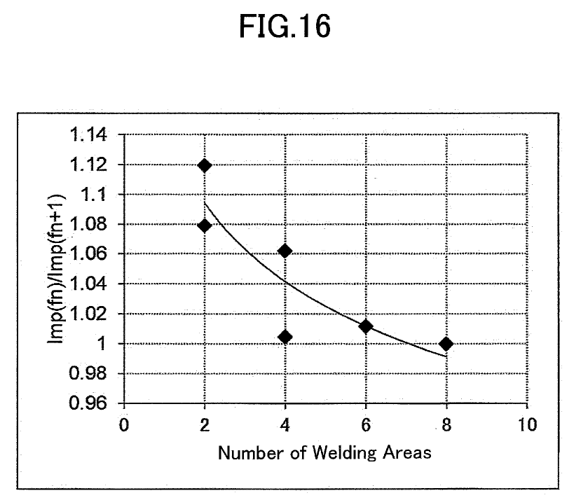

FIG. 16 is a graph illustrating a relationship between the number of weld areas and the impedance variation rate. In FIG. 16, the abscissa indicates the number of weld areas, and the ordinate indicates the impedance variation rate (Imp(fn)/Imp(fn+1)) in the region indicated by (ii) in FIG. 13B, FIG. 14B, and FIG. 15B. It was confirmed from FIG. 16 that the impedance variation rate can be reduced by increasing the number of weld areas.

### (6) Long Sound and Noise

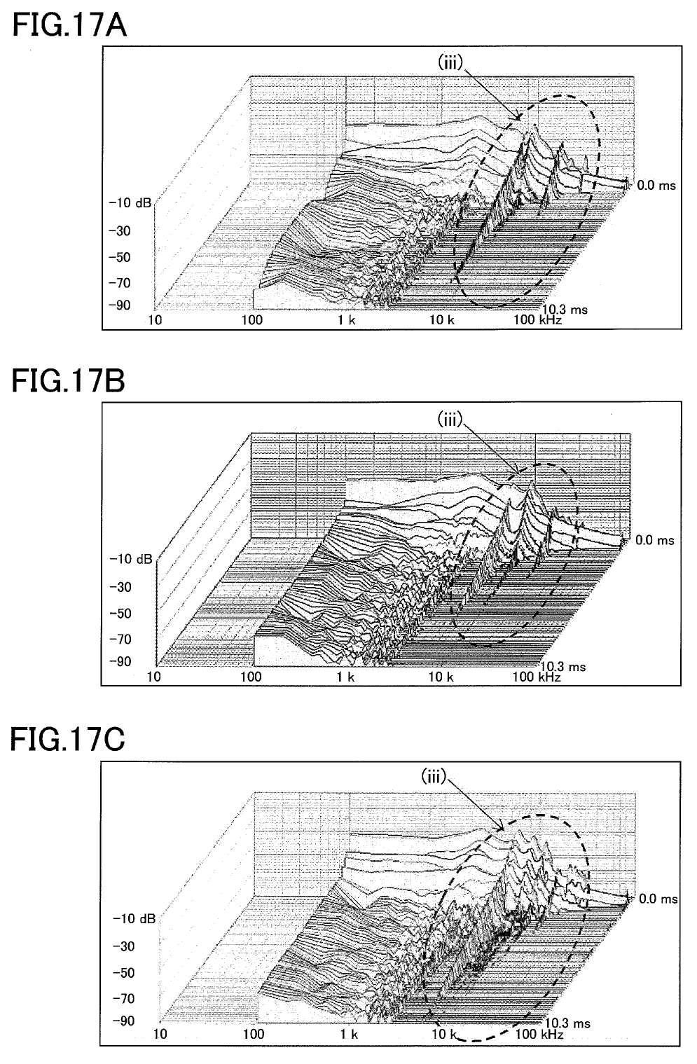

FIG. 17A, FIG. 17B, and FIG. 17C illustrate noise levels of the so-called long sound, as an acoustic effect of generating the sound by driving the sound generating device 1. FIG. 17A illustrates the noise level of the so-called long sound in the first embodiment, FIG. 17B illustrates the noise level of the so-called long sound in the third embodiment, and FIG. 17C illustrates the noise level of the so-called long sound in the comparison example.

In each of FIG. 17A, FIG. 17B, and FIG. 17C, the abscissa indicates the sound generation frequency, and the ordinate indicates the sound pressure level (SPL). In addition, an axis along a depth in each of FIG. 17A, FIG. 17B, and FIG. 17C indicates the time, and the far side indicates a time 0.0 ms when the sound is generated, and the near side indicates a time after 10.3 ms has elapsed after the time when the sound is generated.

In each of FIG. 17A, FIG. 17B, and FIG. 17C, noise generated by the so-called long sound is indicated by (iii). In the comparison example illustrated in FIG. 17C, the SPL of the noise generated by the long sound is high, and the noise generated by the long sound lasts for a long time. On the other hand, in the first embodiment illustrated in FIG. 17A and the third embodiment illustrated in FIG. 17B, it was confirmed that the SPL of the noise generated by the long sound is reduced, and the noise generated by the long sound lasts for a shorter time.

According to each of the embodiments described above, it is possible to minimize weld areas between the armature and the yoke, and stabilize the impedance, so that the noise, such as the so-called long sound, can be reduced.

In addition, by forming the reference weld areas at two locations between the outer surface of the yoke and the two opposing edge parts of the fixing part provided on the base part of the armature, it is possible to prescribe the length of the part of the armature that contributes to the oscillation of the armature. As a result, it is possible to make the amplitude or the like of the armature uniform.

Further, by welding the edge parts of the fixing part and the outer surface of the yoke at the additional weld areas located at positions separated more in the first direction than the reference weld areas, it is possible to manage the size of the magnetic gap formed between the fixing part of the armature and the outer surface of the yoke, and reduce the change in the magnetic gap. Consequently, the impedance variation is reduced, and it is possible to reduce the noise such as the so-called long sound or the like.

Moreover, in the embodiments of the method of manufacturing the sound generating device, the yoke and the armature are moved relative to each other with respect to the welding apparatus, and the additional weld areas are formed, after forming the reference weld areas. For this reason, it is possible to form the weld areas at a plurality of positions with a high accuracy, even when the welding apparatus is only provided with a minimum number of laser emitting parts.

Although the embodiments are numbered with, for example, “first,” “second,” or “third,” the ordinal numbers do not imply priorities of the embodiments.

The present invention is not limited to the embodiments described above. In other words, it is apparent to those skilled in the art that various variations, combinations, sub-combinations, and substitutions may be made to the structures of the embodiments described above without departing from the scope of the present invention.

What is claimed is:

1. A sound generating device comprising:
a yoke made of a magnetic material;
a magnet supported by the yoke;
a coil provided alongside the magnet;
an armature;
an oscillator; and
a case accommodating the yoke, the magnet, the coil, the armature, and the oscillator,
wherein the armature includes a fixing part facing a first direction and overlapped on an outer surface of the yoke, an extension part extending from the fixing part in a second direction opposite to the first direction, and a movable part bent from the extension part and extending in the first direction,
wherein the movable part is inserted into the coil to oppose the magnet, and is connected to the oscillator,
wherein the fixing part includes two opposing edge parts that are spot-welded to the outer surface of the yoke at two reference weld areas that are separated in a perpendicular direction that is perpendicular to the first direction and the second direction, and
wherein the two opposing edge parts of the fixing part and the outer surface of the yoke are spot-welded at at least one additional weld area at a position separated in the first direction from the reference weld areas.

2. The sound generating device as claimed in claim 1, wherein the two opposing edge parts of the fixing part, formed with the reference weld areas, are welded to the outer surface of the yoke at the additional weld area.

3. The sound generating device as claimed in claim 2, wherein an even number of additional weld areas are formed at two or more positions.

4. The sound generating device as claimed in claim 2, wherein the two reference weld areas are formed at positions approximately aligned to an end part of the yoke on a side along the second direction.

5. The sound generating device as claimed in claim 1, wherein the two reference weld areas are formed at positions approximately aligned to an end part of the yoke on a side along the second direction.

6. A method of manufacturing a sound generating device including a yoke made of a magnetic material, a magnet supported by the yoke, a coil provided alongside the magnet, an a/mature, an oscillator, and a case accommodating the yoke, the magnet, the coil, the armature, and the oscillator, the method comprising:
forming on the armature, a fixing part facing a first direction, an extension part extending from the fixing part in a second direction opposite to the first direction, and a movable part bent from the extension part and extending in the first direction;
inserting the movable part into the coil to oppose the magnet, and overlapping the fixing part on an outer surface of the yoke;
spot-welding two edge parts of the fixing part, located at positions along a perpendicular direction that is perpendicular to the first direction and the second direction, to the outer surface of the yoke;
moving the yoke relative to a welding apparatus in the first direction or the second direction, and spot-welding the two edge parts of the fixing part to the outer surface of the yoke, to fix the fixing part to the outer surface of the yoke; and
connecting the movable part and the oscillator after fixing the fixing part to the outer surface of the yoke.

7. The method of manufacturing the sound generating device as claimed in claim 6, further comprising:
spot-welding the two edge parts of the fixing part to the outer surface of the yoke, to form reference weld areas; and
moving the yoke relative to the welding apparatus in the second direction after forming the reference weld areas, and spot-welding the two edge parts of the fixing part to the outer surface of the yoke at positions separated in the first direction from the reference weld areas, to form the additional weld areas.

8. The method of manufacturing the sound generating device as claimed in claim 7, further comprising:
forming an even number of additional weld areas at two or more positions.

9. The method of manufacturing the sound generating device as claimed in claim 7, further comprising:
emitting laser beams from two laser emitting parts of the welding apparatus, located at opposing positions along the perpendicular direction, toward the two edge parts of the fixing part,
wherein the two laser beams travel in oblique irradiating directions such that the two laser beams approach each other toward the armature.

10. The method of manufacturing the sound generating device as claimed in claim 6, further comprising:
emitting laser beams from two laser emitting parts of the welding apparatus, located at opposing positions along the perpendicular direction, toward the two edge parts of the fixing part,
wherein the two laser beams travel in oblique irradiating directions such that the two laser beams approach each other toward the armature.
